(19) United States
(12) Patent Application Publication
(10) Pub. No.: US 2017/0045923 A1
(43) Pub. Date: Feb. 16, 2017

(54) MANAGEMENT DEVICE AND CONNECTION METHOD FOR CONTROLLING CONNECTIONS OF STORAGE NETWORK

(71) Applicant: FUJITSU LIMITED, Kawasaki-shi (JP)

(72) Inventor: Tomonari HORIKOSHI, Yokohama (JP)

(73) Assignee: FUJITSU LIMITED, Kawasaki-shi (JP)

(21) Appl. No.: 15/178,021

(22) Filed: Jun. 9, 2016

(30) Foreign Application Priority Data
Aug. 10, 2015 (JP) 2015-158064

(51) Int. Cl. G06F 1/26; G06F 9/44

(52) U.S. Cl. CPC G06F 1/26; G06F 9/4406

(57) ABSTRACT

A management device includes a memory device and a processor. The memory device is configured to store recognition sequence information indicating an expected sequence of recognition processing for recognizing each of paths interconnecting any one of first connection units and any one of second connection units. The recognition processing is performed at a time of power-on of a server device including the first connection units. The second connection units are included in respective storage devices. Each of the first connection units and the second connection units is connected to any one of connection ports included in a switch. The processor is configured to monitor a sequence of the recognition processing at the time of power-on, and control the switch, upon detecting a first path for which the recognition processing is performed in a different sequence from the expected sequence, to temporarily cut off connection ports existing on the first path.

### CROSS-REFERENCE TO RELATED APPLICATION

This application is based upon and claims the benefit of priority of the prior Japanese Patent Application No. 2015-158064, filed on Aug. 10, 2015, the entire contents of which are incorporated herein by reference.

### FIELD

The embodiments discussed herein are related to a management device and a method for controlling connections of a storage network.

### BACKGROUND

A storage system is being widely used in which a plurality of server devices and storage devices including memory devices such as, for example, a redundant array of inexpensive disks (RAID) are interconnected through a storage area network (SAN). As the storage system with the SAN connection, for example, there is a system which uses a fibre channel (FC) for a communication between devices and interconnects the devices through an optical fiber or an FC switch. By using the FC, a high access performance to a storage device may be implemented.

In the storage system with the SAN connection as described above, there is a technique called “SAN boot” in which an operating system (OS) image is stored in a storage device, and a server device starts an OS from the OS image stored in the storage device. In an environment adopting the SAN boot, even when a failure occurs in a server device, another server device reads the same OS image from the storage device so that the operation may be restarted quickly. Further, when the SAN boot is adopted, the server device may be configured as a diskless server device so that a failure resistance may also be improved.

In addition, there has been suggested an integrated storage system which smoothly performs resetting of address information due to an addition of a network node or a replacement thereof at the time of an occurrence of a failure. This integrated storage system provides a host adapter between a server device and a switch and manages address information for each combination of a storage device and the host adapter so as to automatize the resetting of an address due to, for example, a maintenance and replacement of a network node.

In addition, there has been suggested a management device which effectively assigns an identification number for data access to each of a plurality of storage devices which are connected in series. This management device calculates an expected value of an identification number corresponding to a connection sequence and determines, when assigning an identification number to one storage device, whether the identification number and an expectation value thereof match with each other. When it is determined that the identification number and the expected value do not match with each other, the management device sets the connection between the storage device and the subsequent storage devices thereof into a cutoff state.

Related techniques are disclosed in, for example, Japanese Laid-Open Patent Publication No. 2006-285597 and Japanese Laid-Open Patent Publication No. 2013-011926.

### SUMMARY

According to an aspect of the present invention, provided is a management device including a memory device and a processor. The memory device is configured to store therein recognition sequence information indicating an expected sequence of recognition processing for recognizing each of paths interconnecting any one of first connection units and any one of second connection units. The recognition processing is performed at a time of power-on of a server device including the first connection units. The second connection units are included in respective storage devices. Each of the first connection units and the second connection units is connected to any one of connection ports included in a switch. The processor is configured to monitor a sequence of the recognition processing at the time of power-on. The processor is configured to control the switch, upon detecting a first path for which the recognition processing is performed in a different sequence from the expected sequence, to temporarily cut off connection ports existing on the first path.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

When a server device is powered on, a basic input/output system (BIOS) is started, a boot loader is read from an initially recognized external storage device into a memory, and an OS is started by the boot loader. Hence, in an environment where a plurality of storage devices are connected to the powered-on server device through the SAN, the OS is smoothly started by the SAN boot when a storage device having an OS image is initially recognized.

In the above-described SAN connection environment, a recognition sequence of storage devices may be changed depending on a link-up status of the FC. Hence, the server device may recognize another storage device prior to the storage device having the OS image. In this case, a startup error of the OS occurs. As long as the recognition sequence of storage devices is assured, the OS may be smoothly started by the SAN boot, regardless of the link-up status of the FC.

### BRIEF DESCRIPTION OF DRAWINGS

FIG. 1 is a diagram illustrating an example of a storage system according to a first embodiment;

FIG. 2 is a diagram illustrating an example of a storage system according to a second embodiment;

FIG. 3 is a diagram illustrating an exemplary hardware configuration of a management device according to the second embodiment;

FIG. 4 is a diagram illustrating an exemplary functional configuration of the management device according to the second embodiment;

FIG. 5 is a diagram illustrating an example of recognition sequence information according to the second embodiment;

FIG. 6 is a diagram illustrating an example of connection line information according to the second embodiment;

FIG. 7 is a diagram illustrating an example of current connection information according to the second embodiment;

FIG. 8 is a flowchart illustrating a flow of operations performed by the management device according to the second embodiment;

FIG. 9 is a diagram illustrating an example (in a case where a connection sequence is incorrect) of a method of determining a connection sequence according to the second embodiment;

FIG. 10 is a diagram illustrating an example (in a case where a connection sequence is correct) of a method of determining a connection sequence according to the second embodiment;

FIG. 11 is a diagram illustrating an example of a storage system according to a modification (Modification#1) of the second embodiment;

FIG. 12 is a diagram illustrating an example of recognition sequence information according to the modification (Modification#1) of the second embodiment;

FIG. 13 is a diagram illustrating an example of connection line information according to the modification (Modification#1) of the second embodiment; and

FIG. 14 is a flowchart illustrating a flow of operations performed by a management device according to another modification (Modification#2) of the second embodiment.

### DESCRIPTION OF EMBODIMENTS

Hereinafter, embodiments of the present disclosure will be described with reference to the accompanying drawings. In the following descriptions and the drawings, components having a substantially identical function will be denoted by the same reference numerals such that overlapping descriptions thereof may be omitted.

### First Embodiment

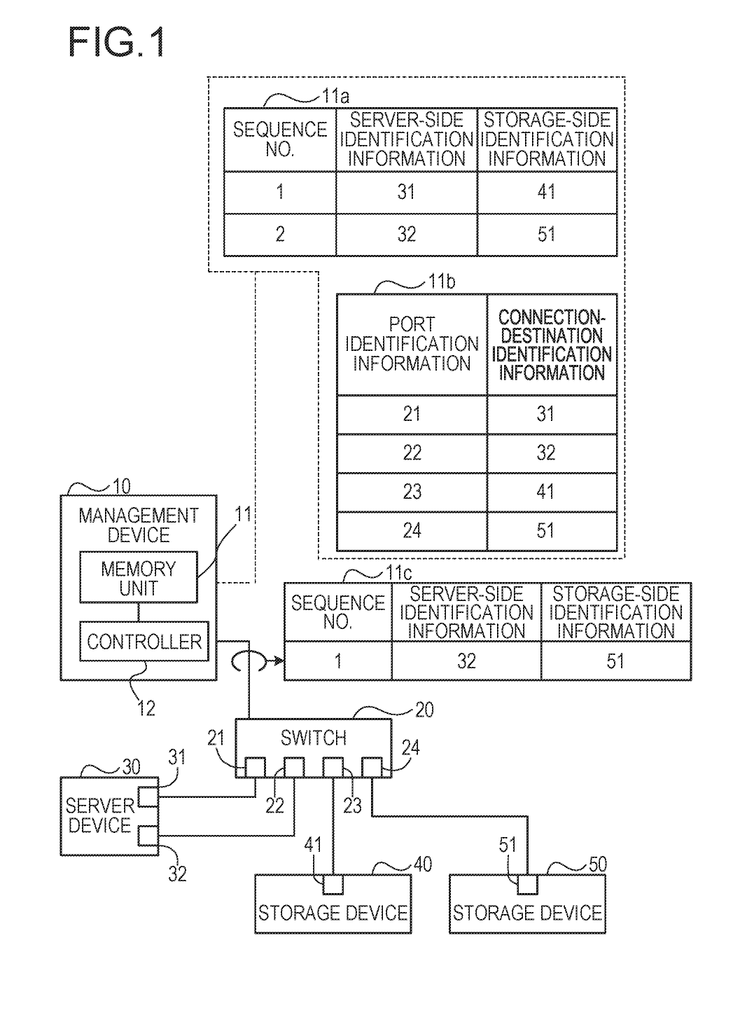

A first embodiment will be described with reference to FIG. 1. FIG. 1 is a diagram illustrating an example of a storage system according to the first embodiment.

As illustrated in FIG. 1, the storage system according to the first embodiment includes a management device 10, a switch 20, a server device 30, and storage devices 40 and 50. The number of each of the switch, the server device, and the storage device is not limited to the example of FIG. 1.

The management device 10 is a computer that manages the switch 20, the server device 30, and the storage devices 40 and 50. The switch 20 includes connection ports 21 to 24. The switch 20 is, for example, an FC switch. The server device 30 is a computer that includes first connection units 31 and 32 which are connected to the connection ports 21 and 22, respectively.

The storage device 40 includes a second connection unit 41 which is connected to the connection port 23. The storage device 50 includes a second connection unit 51 which is connected to the connection port 24. Each of the storage devices 40 and 50 includes a memory device (not illustrated) such as, for example, a hard disk drive (HDD) or a solid state drive (SSD). In the example of FIG. 1, it is assumed that an OS image used by the management device 10 is stored in the storage device 40.

The management device 10 includes a memory unit 11 and a controller 12. The memory unit 11 is a volatile memory device such as, for example, a random access memory (RAM) or a nonvolatile storage device such as, for example, an HDD or a flash memory. The controller 12 is a processor such as, for example, a central processing unit (CPU) or a digital signal processor (DSP). The controller 12 may be an electric circuit such as, for example, an application specific integrated circuit (ASIC) or a field programmable gate array (FPGA). The controller 12 executes a program stored in, for example, the memory unit 11 or another memory.

The memory unit 11 includes recognition sequence information 11a and connection line information 11b. The recognition sequence information 11a indicates a sequence of recognition processing, which is performed at the time of power-on of the server device 30, for paths that interconnect the first connection units 31 and 32 and the second connection units 41 and 51.

In the example of FIG. 1, the path interconnecting the first connection unit 31 and the second connection unit 41 is set as a path for which recognition processing is first performed (Sequence No. 1). In addition, the path interconnecting the first connection unit 32 and the second connection unit 51 is set as a path for which recognition processing is secondarily performed (Sequence No. 2). In the drawing, for convenience of description, the reference numerals of the first connection units are described as server-side identification information, and the reference numerals of the second connection units are described as storage-side identification information.

The connection line information 11b indicates devices connected to the connection ports 21 to 24 of the switch 20, respectively. In the example of FIG. 1, the first connection unit 31 is connected to the connection port 21, and the first connection unit 32 is connected to the connection port 22. Further, the second connection unit 41 is connected to the connection port 23, and the second connection unit 51 is connected to the connection port 24. In the drawing, for convenience of description, the reference numerals of the connection ports are described as port identification information, and the reference numerals of the first connection units and the second connection units are described as connection-destination identification information.

The server-side identification information, the storage-side identification information, and the connection-destination identification information may be represented by using, for example, worldwide port names (WWPN) of ports connected to the connection ports 21 to 24 of the switch 20, respectively.

The WWPN is a name set for an FC port (a host bus adapter (HBA), a channel adapter (CA), and a port of a FC switch) and refers to a media access control (MAC) global address of the Institute of Electrical and Electronic Engineers (IEEE). The WWPN is used as an identifier at the time of an FC port login. The switch 20 detects a WWPN of an FC port connected to each of the connection ports 21 to 24 and assigns a port number (port address) to a device having the detected WWPN. The port number is valid only while the device is logged in and referred-to when data is routed.

The controller 12 monitors the sequence of the recognition processing at the time of the power-on of the server device 30. Then, when detecting a path for which the recognition processing has been performed in a different sequence from the sequence indicated in the recognition sequence information 11a, the controller 12 controls the switch 20 to temporarily cut off connection ports existing on the detected path. Further, after the temporary cutoff of the connection ports existing on the detected path, the controller 12 causes the connection ports to be reconnected.

For example, the controller 12 monitors, through the switch 20, the log of authentication processing performed for each path, and generates current connection information 11c which records a pair of server-side identification information and storage-side identification information that corresponds to a path for which the authentication processing has been completed. In the example of FIG. 1, the authentication processing is completed first (Sequence No. 1) for the path interconnecting the first connection unit 32 and the second connection unit 51 (the server-side identification information is 32, and the storage-side identification information is 51).

The controller 12 compares the recognition sequence information 11a and the current connection information 11c with each other. In this example, the recognition sequence information 11a and the current connection information 11c are inconsistent with each other. Accordingly, the controller 12 determines that the recognition processing has been performed in a different sequence from the sequence indicated in the recognition sequence information 11a. Then, the controller 12 cuts off the connection ports 22 and 24 corresponding to the server-side identification information 32 and the storage-side identification information 51, respectively, with reference to the connection line information 11b. Thereafter, the controller 12 causes the connection ports 22 and 24 to be reconnected.

In general, since link-up of the FC is initiated in a preset sequence, it is expected that the change of the recognition sequence as represented in FIG. 1 would not occur. However, such a change may occur depending on an authentication error or a load condition of the storage devices 40 and 50. However, as described above, by controlling the switch 20 to temporarily cut off the connection ports 22 and 24, which are involved in the change of the recognition sequence, and to reconnect the connection ports 22 and 24, the FC is linked up in an expected sequence, and the storage devices 40 and 50 are recognized in a correct sequence. When the change of the recognition sequence occurs again after the reconnection, the cutoff and the reconnection of the connection ports 22 and 24 are repeatedly performed.

The first embodiment has been described. According to the first embodiment, the recognition sequence of the storage devices may be assured. For example, when the storage system according to the first embodiment is applied to a storage system adopting the SAN boot, it is possible to enable the storage device having the OS image to be initially recognized, and suppress a startup error of the OS.

The technique of the first embodiment implements normalization of the recognition sequence through the control of the switch. That is, since the technique of the first embodiment requires no specific mechanism in the BIOS and the OS of the server device and the storage devices, it has high applicability.

Thus, there is an advantage in that the technique of the first embodiment may be easily and additionally applied to a conventional storage system.

### Second Embodiment

Next, a second embodiment will be described.

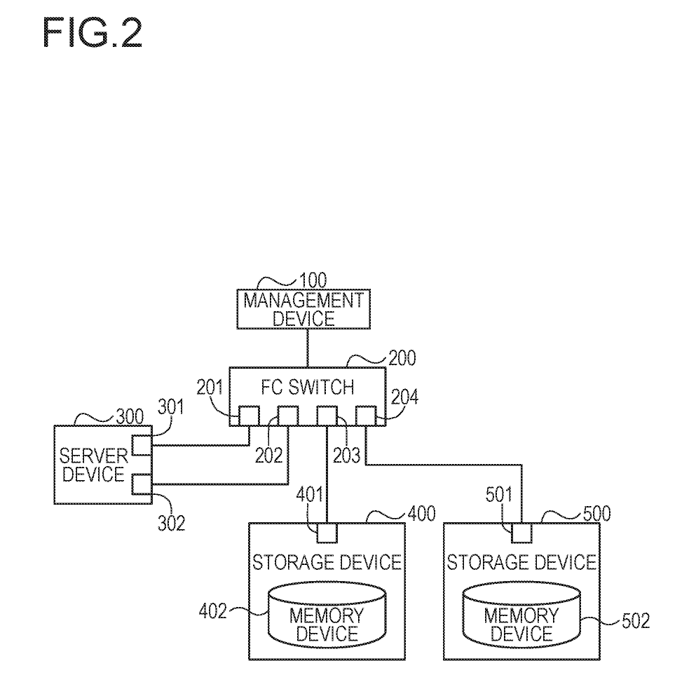

First, a storage system according to the second embodiment will be described with reference to FIG. 2. FIG. 2 is a diagram illustrating an example of a storage system according to the second embodiment. The descriptions will be made in consideration of a storage system with the SAN connection using the FC.

As illustrated in FIG. 2, the storage system according to the second embodiment includes a management device 100, an FC switch 200, a server device 300, and storage devices 400 and 500. The number of each of the switch, the server device, and the storage device is not limited to the example of FIG. 2.

The management device 100 is a computer that manages the FC switch 200, the server device 300, and the storage devices 400 and 500. The management device 100 is connected to the FC switch 200 by using, for example, a local area network (LAN). The FC switch 200 includes connection ports 201 to 204. The server device 300 is a computer that includes HBAs 301 and 302 which are connected to the connection ports 201 and 202, respectively.

The storage device 400 includes a CA 401, which is connected to the connection port 203, and a memory device 402. The storage device 500 includes a CA 501, which is connected to the connection port 204, and a memory device 502. Each of the memory devices 402 and 502 is, for example, a redundant RAID device in which, for example, a plurality of HDDs or SSDs are connected to each other. It is assumed that an OS image used by the server device 300 is stored in the memory device 402.

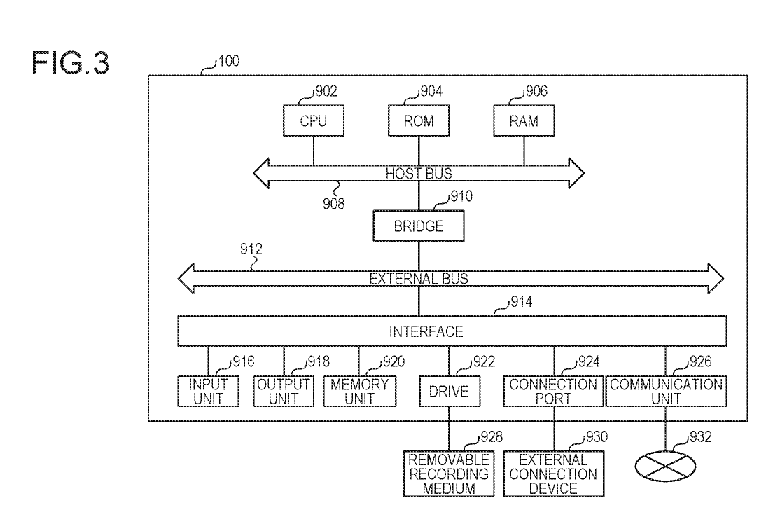

Next, hardware of the management device 100 will be described with reference to FIG. 3. FIG. 3 is a diagram illustrating an exemplary hardware configuration of the management device according to the second embodiment.

The function of the management device 100 may be implemented by using, for example, the hardware resource of the information processing device as illustrated in FIG. 3. That is, the function of the management device 100 is implemented by executing a computer program to control the hardware illustrated in FIG. 3.

As illustrated in FIG. 3, the hardware mainly includes a CPU 902, a read-only memory (ROM) 904, a RAM 906, a host bus 908, and a bridge 910. Further, the hardware includes an external bus 912, an interface 914, an input unit 916, an output unit 918, a memory unit 920, a drive 922, a connection port 924, and a communication unit 926.

The CPU 902 functions as, for example, an arithmetic processing device or a control device and executes various programs recorded in the ROM 904, the RAM 906, the memory unit 920, or a removable recording medium 928 so as to control the entirety or a part of an operation of each component. The ROM 904 is an exemplary memory device that stores therein, for example, a program to be read into the CPU 902 or data used for an arithmetic operation. The RAM 906 temporarily or permanently stores therein, for example, a program to be read into the CPU 902 or various parameters which vary when the program is executed.

These components are connected to each other through, for example, the host bus 908 capable of transmitting data at a high speed. The host bus 908 is connected to the external bus 912, which transmits data at a relatively low speed, through the bridge 910. As the input unit 916, for example, a mouse, a keyboard, a touch panel, a touch pad, a button, a switch, and a lever are used. As the input unit 916, a remote controller which is capable of transmitting a control signal by using infrared rays or other radio waves may also be used.

As the output unit 918, a display device such as, for example, a cathode ray tube (CRT), a liquid crystal display (LCD), a plasma display panel (PDP), or an electro-luminescence display (ELD) is used. As the output unit 918, an audio output device such as, for example, a speaker or a headphone, or a printer may also be used. That is, the output unit 918 is a device capable of outputting information visually or audibly.

The memory unit 920 is a device that stores therein various data. As the memory unit 920, a magnetic memory device such as, for example, an HDD is used. As the memory unit 920, a semiconductor memory device such as an SSD or a RAM disk, an optical memory device, or an optical magnetic memory device may also be used.

The drive 922 is a device that reads information recorded in the removable recording medium 928 or records information in the removable recording medium 928. As the removable recording medium 928, for example, a magnetic disk, an optical disk, an optical magnetic disk, or a semiconductor memory is used.

The connection port 924 is a port configured to be connected to an external connection device 930, and is, for example, a universal serial bus (USB) port, an IEEE 1394 port, a small computer system interface (SCSI), an RS-232C port, or an optical audio terminal. As the external connection device 930, for example, a printer is used.

The communication unit 926 is a communication device configured to be connected to a network 932. As the communication unit 926, for example, a communication circuit for a wired or wireless LAN, a communication circuit for a wireless USB (WUSB), a communication circuit or router for optical communication, a communication circuit or router for an asymmetric digital subscriber line (ADSL), or a communication circuit for a mobile phone network is used. The network 932 which is connected to the communication unit 926 is a wired or wireless network and includes, for example, the Internet, a LAN, a broadcasting network, and a satellite communication line.

The function of the server device 300 may also be implemented by using the hardware resource exemplified in FIG. 3. In implementing the functions of the management device 100 and the server device 300, a part of the hardware resource exemplified in FIG. 3 may be omitted, or a new component may be added, depending on aspects of the embodiment.

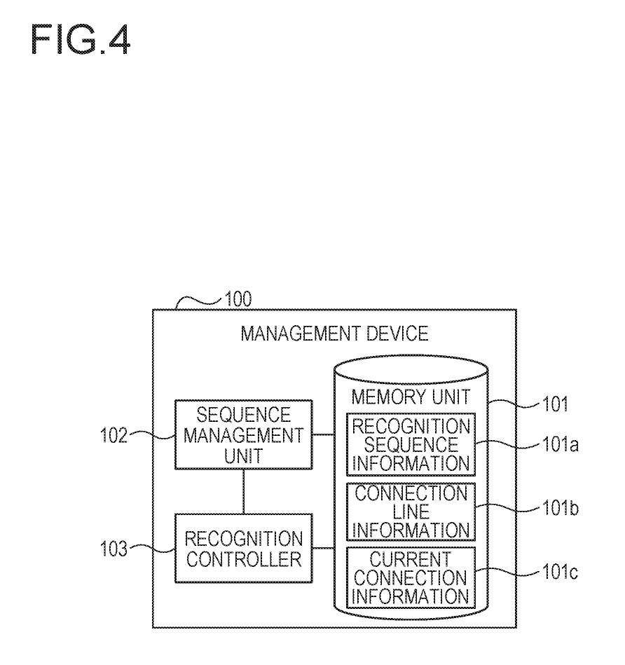

Next, the function configuration of the management device 100 will be described with reference to FIG. 4. FIG. 4 is a diagram illustrating an exemplary function configuration of the management device according to the second embodiment.

As illustrated in FIG. 4, the management device 100 includes a memory unit 101, a sequence management unit 102, and a recognition controller 103. The function of the memory unit 101 may be implemented by using, for example, the above-described RAM 906 or memory unit 920. The functions of the sequence management unit 102 and the recognition controller 103 may be implemented by using, for example, the above-described CPU 902.

The memory unit 101 stores therein recognition sequence information 101a, connection line information 101b, and current connection information 101c. The recognition sequence information 101a and the connection line information 101b are preset. The current connection information 101c is generated after the power-on of the server device 300.

The recognition sequence information 101a indicates an expected value of a sequence in which the server device 300 recognizes the storage devices. When the storage devices are recognized in the sequence indicated in the recognition sequence information 101a, the server device 300 may normally start the OS by the SAN boot.

An FC port login is performed for each of paths (access paths) that interconnect the HBAs of the server device 300 and the CAs of the storage devices. When the FC port login is completed so that a path is set, an access via the FC switch 200 may be implemented.

In the storage system exemplified in FIG. 2, there are two paths, that is, Path#1 which interconnects the HBA 301 and the CA 401 via the connection ports 201 and 203, and Path#2 which interconnects the HBA 302 and the CA 501 via the connection ports 202 and 204. The setting of the paths is performed by specifying WWPNs of the FC ports (HBAs 301 and 302) of the server device 300 and the FC ports (CAs 401 and 501) of the storage devices 400 and 500.

For example, Path#1 is set by specifying a pair of the WWPN (00:00:00:00:00:00:01) of the HBA 301 connected to the connection port 201 and the WWPN (20:00:00:00:00:00:01) of the CA 401 connected to the connection port 203. Path#2 is set by specifying a pair of the WWPN (00:00:00:00:00:00:02) of the HBA 302 connected to the connection port 202 and the WWPN (20:00:00:00:00:00:02) of the CA 501 connected to the connection port 204.

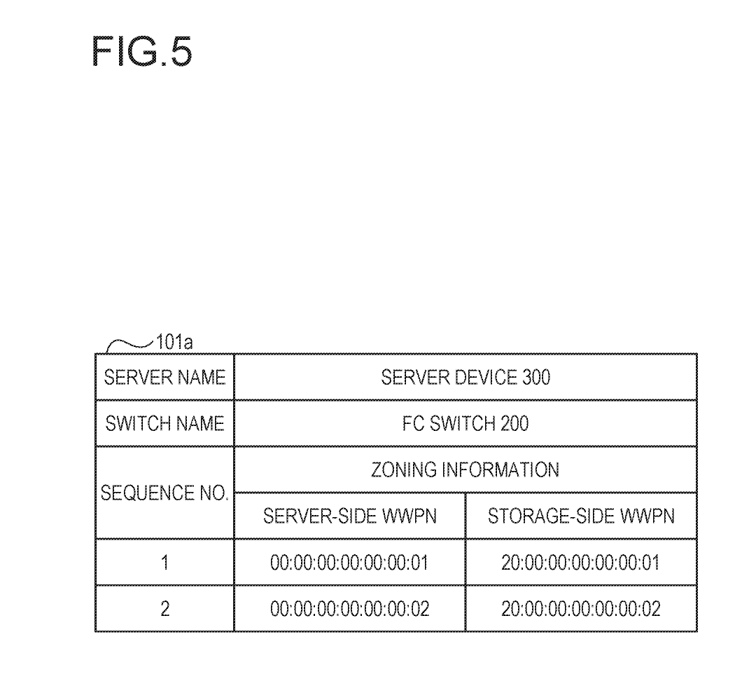

A method of dividing accessible areas by the above-described pair of WWPNs may be called WWPN zoning. As illustrated in FIG. 5, the recognition sequence information 101a is formed for each combination of the server device 300 and the FC switch 200. The recognition sequence information 101a indicates a recognition sequence (a connection sequence of access paths) with zoning information indicating the status of the WWPN zoning. FIG. 5 is a diagram illustrating an example of the recognition sequence information according to the second embodiment. The example of FIG. 5 represents that Path#1 is to be first recognized (Sequence No. 1) and Path#2 is to be secondarily recognized (Sequence No. 2), as an expected value.

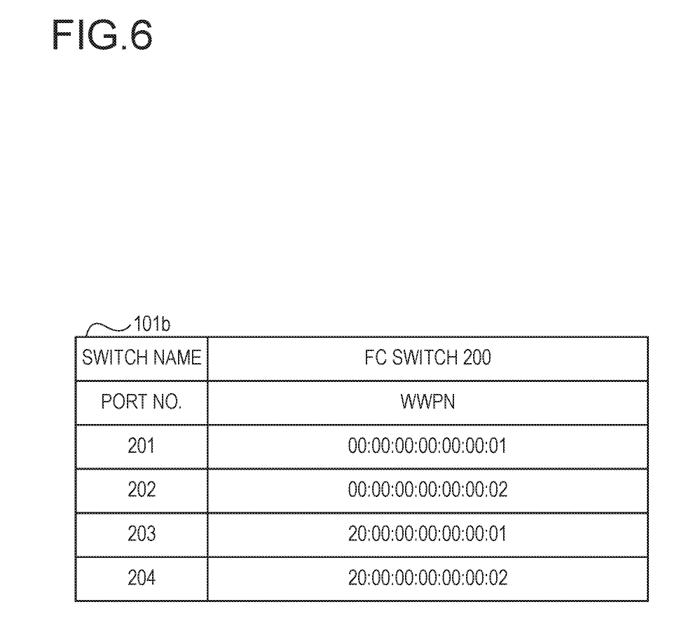

As illustrated in FIG. 6, the connection line information 101b indicates WWPNs of the FC ports (the HBAs, the CAs, and the like) connected to the connection ports 201 to 204 of the FC switch 200, respectively. FIG. 6 is a diagram illustrating an example of the connection line information according to the second embodiment.

In the example of FIG. 6, the FC port of Port No. 201 (the connection port 201) and the HBA 301 having the WWPN (00:00:00:00:00:00:01) are connected to each other. The FC port of Port No. 202 (the connection port 202) and the HBA 302 having the WWPN (00:00:00:00:00:00:02) are connected to each other.

The FC port of Port No. 203 (the connection port 203) and the CA 401 having the WWPN (20:00:00:00:00:00:01) are connected to each other. The FC port of Port No. 204 (the connection port 204) and the CA having the WWPN (20:00:00:00:00:00:02) are connected to each other. For convenience of description, a port number is represented by a reference numeral of a connection port. By referring to the connection line information 101b, the FC ports connected to the connection ports 201 to 204 may be recognized.

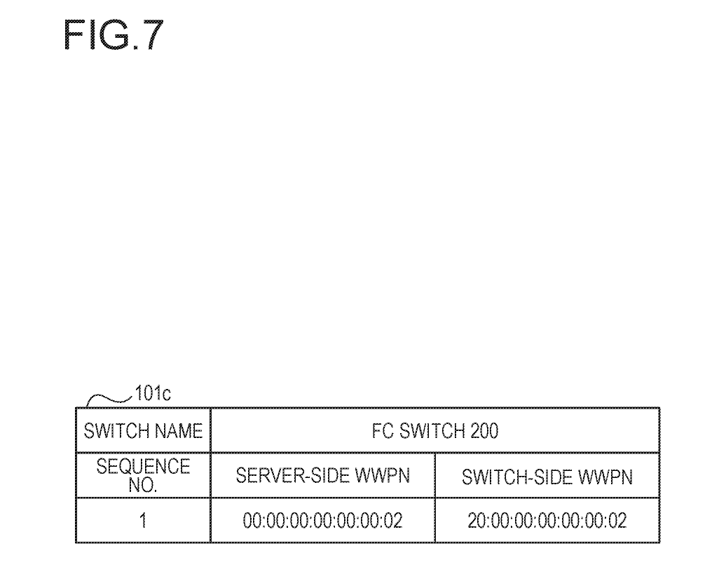

The current connection information 101c indicates a completion sequence of the FC port login performed at the time of the power-on of the server device 300. As illustrated in FIG. 7, the current connection information 101c records a pair of a server-side WWPN and a storage-side WWPN which corresponds to a path for which the FC port login has been completed. FIG. 7 is a diagram illustrating an example of the current connection information according to the second embodiment. The example of FIG. 7 represents a case where the FC port login is first completed for the path interconnecting the HBA 302 and the CA 501, and the server device 300 recognizes the storage device 500.

The sequence management unit 102 registers a preset recognition sequence in the recognition sequence information 101a and registers the WWPNs of the FC ports (the HBAs 301 and 302 and the CAs 401 and 501) connected to the connection ports 201 to 204 in the connection line information 101b.

The recognition controller 103 monitors the power-on of the server device 300 and the FC port login. Then, the recognition controller 103 generates current connection information 101c on the basis of the log of the FC port login performed at the time of the power-on of the server device 300. Then, the recognition controller 103 compares the recognition sequence information 11a and the generated current connection information 11c with each other.

When detecting a path for which the FC port login has been completed in a different sequence from the expected value, the recognition controller 103 makes the connection port of the FC switch 200 which forms the path to be offline. Thereafter, the recognition controller 103 returns the offline connection port into online. When the connection port is returned into online, the server device 300 re-performs the FC port login.

The recognition controller 103 also performs generation of current connection information 101c and comparison between the recognition sequence information 101a and the current connection information 101c for the FC port login re-performed by the server device 300 in the same manner as described above. When detecting a path for which the FC port login has been completed in a different sequence from the expected value again, the recognition controller 103 makes the connection port of the FC switch 200 which forms the path to be offline. As described above, by temporarily cutting off a path for which the login processing has been performed in a different sequence from the expected sequence and reconnecting the path, a correct recognition sequence is assured.

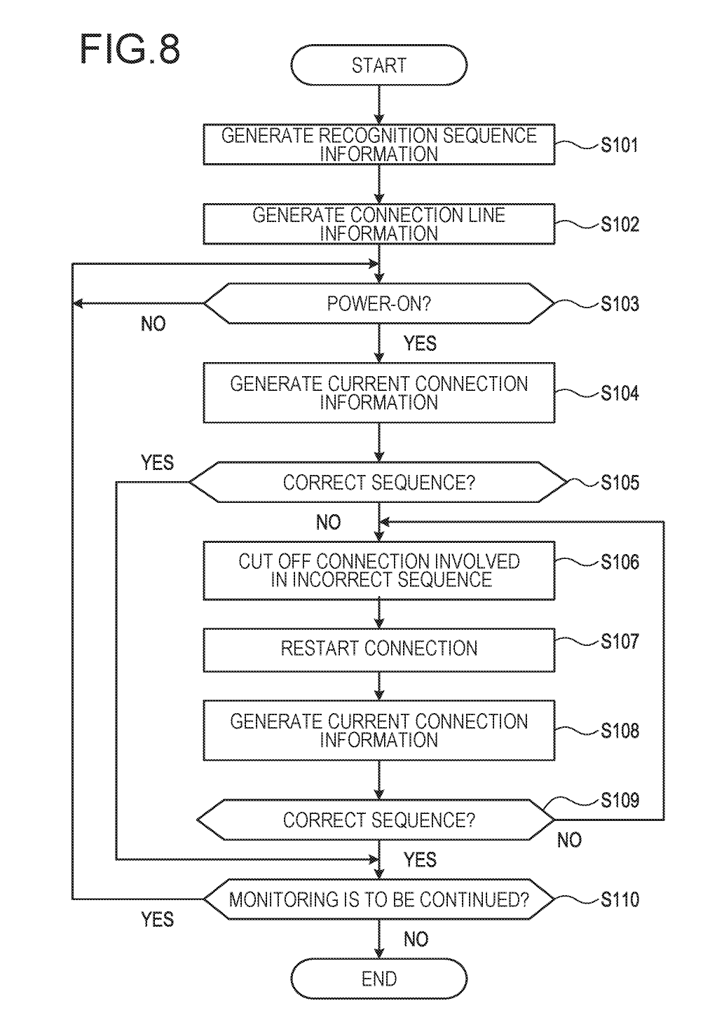

Next, a flow of the operations performed by the management device 100 will be described with reference to FIG. 8. FIG. 8 is a flowchart illustrating a flow of the operations performed by the management device according to the second embodiment.

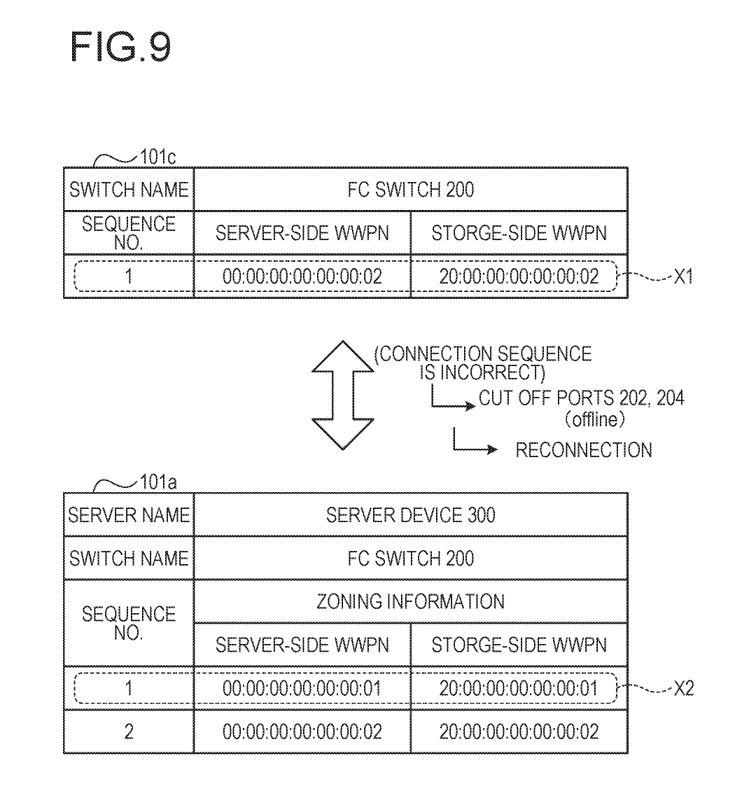

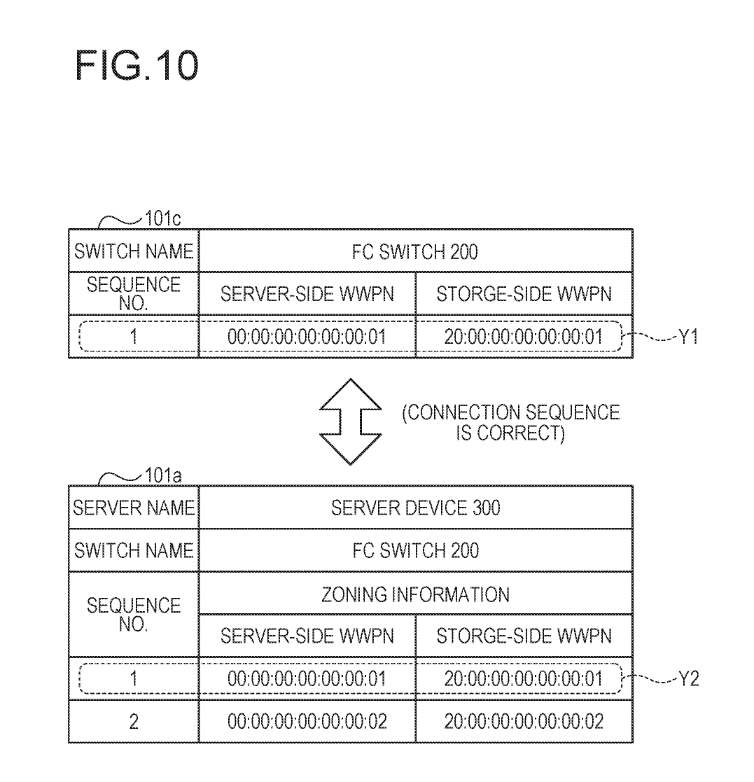

In addition, FIGS. 9 and 10 will be appropriately referred to in the following descriptions. FIG. 9 is a diagram illustrating an example (in a case where a connection sequence is incorrect) of a method of determining a connection sequence according to the second embodiment. FIG. 10 is a diagram illustrating an example (in a case where a connection sequence is incorrect) of a method of determining a connection sequence according to the second embodiment.

(S101) The sequence management unit 102 generates recognition sequence information 101a. For example, as illustrated in FIG. 5, the sequence management unit 102 registers pairs of a server-side WWPN and a storage-side WWPN as recognition sequence information 101a in a preset sequence.

(S102) The sequence management unit 102 generates connection line information 101b. For example, the sequence management unit 102 acquires WWPNs of the FC ports connected to the FC switch 200 and registers the WWPNs corresponding to the connection ports 201 to 204, respectively, as connection line information 101b as illustrated in FIG. 6.

(S103) The recognition controller 103 monitors the power-on of the server device 300. When the power-on of the server device 300 is detected, the processing proceeds to S104. When the power-on of the server device 300 is not detected, the processing proceeds to S103 again, and the recognition controller 103 continues to monitor the power-on.

(S104) The recognition controller 103 monitors a login (FC port login) to the FC switch 200 by the server device 300. When an FC port login is performed, the recognition controller 103 generates current connection information 101c on the basis of the log of the FC port login.

For example, the recognition controller 103 acquires the log of the FC port login from the FC switch 200, and identifies a server-side WWPN and a storage-side WWPN which correspond to a path for which the FC port login has been completed. Then, as illustrated in FIG. 7, the recognition controller 103 registers the identified server-side WWPN and storage-side WWPN as current connection information 101c while associating the WWPNs with the completion sequence of the FC port login.

(S105) The recognition controller 103 compares the recognition sequence information 101a and the current connection information 101c generated in S104 with each other and determines whether the connection sequence (the completion sequence of the FC port login) is correct. That is, the recognition controller 103 determines whether the contents of the recognition sequence information 101a and the contents of the current connection information 101c are consistent with each other.

For example, when the current connection information 101c illustrated in FIG. 9 is obtained, information X1 corresponding to Sequence No. 1 of the current connection information 101c and information X2 corresponding to Sequence No. 1 of the recognition sequence information 101a are inconsistent with each other. In this case, the recognition controller 103 determines that the contents of the recognition sequence information 101a and the contents of the current connection information 101c are inconsistent with each other. That is, the recognition controller 103 determines that the connection sequence is incorrect.

When the current connection information 101c illustrated in FIG. 10 is obtained, information Y1 corresponding to Sequence No. 1 of the current connection information 101c and information Y2 corresponding to Sequence No. 1 of the recognition sequence information 101a are consistent with each other. In this case, the recognition controller 103 determines that the contents of the recognition sequence information 101a and the contents of the current connection information 101c are consistent with each other. That is, the recognition controller 103 determines that the connection sequence is correct.

When the connection sequence is correct, the processing proceeds to S110. When the connection sequence is incorrect, the processing proceeds to S106.

(S106) The recognition controller 103 cuts off the connection to the FC switch 200, which is involved in the incorrect connection sequence. For example, the pair of the server-side WWPN (00:00:00:00:00:00:02) and the storage-side WWPN (20:00:00:00:00:00:02) which is indicated in the current connection information 101c corresponds to Sequence No. 2 of the recognition sequence information 101a. That is, the connection corresponding to the pair of the server-side WWPN (00:00:00:00:00:00:02) and the storage-side WWPN (20:00:00:00:00:00:02) is the connection to the FC switch 200, which is involved in the incorrect connection sequence.

In this case, the recognition controller 103 makes the connection port 202 (Port No. 202) corresponding to the server-side WWPN (00:00:00:00:00:00:02) to be offline, with reference to the connection line information 101b. Further, the recognition controller 103 makes the connection port 204 (Port No. 204) corresponding to the storage-side WWPN (20:00:00:00:00:00:02) to be offline.

(S107) The recognition controller 103 restarts the connection to the ports (the connection ports 201 to 204 of the FC switch 200) in the sequence indicated in the recognition sequence information 101a.

For example, with reference to the recognition sequence information 101a and the connection line information 101b, the recognition controller 103 makes the connection port 201 (Port No. 201) corresponding to the server-side WWPN (00:00:00:00:00:00:01) which corresponds to Sequence No. 1 to be online. Subsequently, the recognition controller 103 makes the connection port 203 (Port No. 203) corresponding to the storage-side WWPN (20:00:00:00:00:00:01) which corresponds to Sequence No. 1 to be online.

Next, the recognition controller 103 makes the connection port 202 (Port No. 202) corresponding to the server-side WWPN (00:00:00:00:00:00:02) which corresponds to Sequence No. 2 to be online. Subsequently, the recognition controller 103 makes the connection port 204 (Port No. 204) corresponding to the storage-side WWPN (20:00:00:00:00:00:02) which corresponds to Sequence No. 2 to be online.

(S108) The recognition controller 103 monitors a login (FC port login) to the FC switch 200 by the server device 300. When the FC port login is performed, the recognition controller 103 generates current connection information 101c on the basis of the log of the FC port login.

For example, the recognition controller 103 acquires the log of the FC port login from the FC switch 200, and identifies a server-side WWPN and a storage-side WWPN which correspond to a path for which the FC port login has been completed. Then, the recognition controller 103 registers the identified server-side WWPN and storage-side WWPN as current connection information 101c while associating the WWPNs with the completion sequence of the FC port login.

(S109) The recognition controller 103 compares the recognition sequence information 101a and the current connection information 101c generated in S108 with each other and determines whether the connection sequence (the completion sequence of the FC port login) is correct. That is, the recognition controller 103 determines whether the contents of the recognition sequence information 101a and the contents of the current connection information 101c are consistent with each other. When it is determined that the connection sequence is correct, the processing proceeds to S110. When it is determined that the connection sequence is incorrect, the processing proceeds to S106.

(S110) The recognition controller 103 determines whether to continue the monitoring of the power-on. For example, when a user instructs to end the monitoring, it is determined that the monitoring of the power-on is not to be continued. When it is determined that the monitoring of the power-on is to be continued, the processing proceeds to S103. When it is determined that the monitoring of the power-on is not to be continued, the series of operations illustrated in FIG. 8 are ended.

The above-described technique may be identically applied even when the number of the connection ports of the FC switch, the number of the HBAs of the server device, and the number of the storage devices or the CAs are modified. Hereinafter, the extensibility of the above-described technique will be described by exemplifying a case (Modification#1) where the number of the connection ports of the FC switch is 6, the number of the HBAs of the server device is 3, and the number of the storage devices is 3.

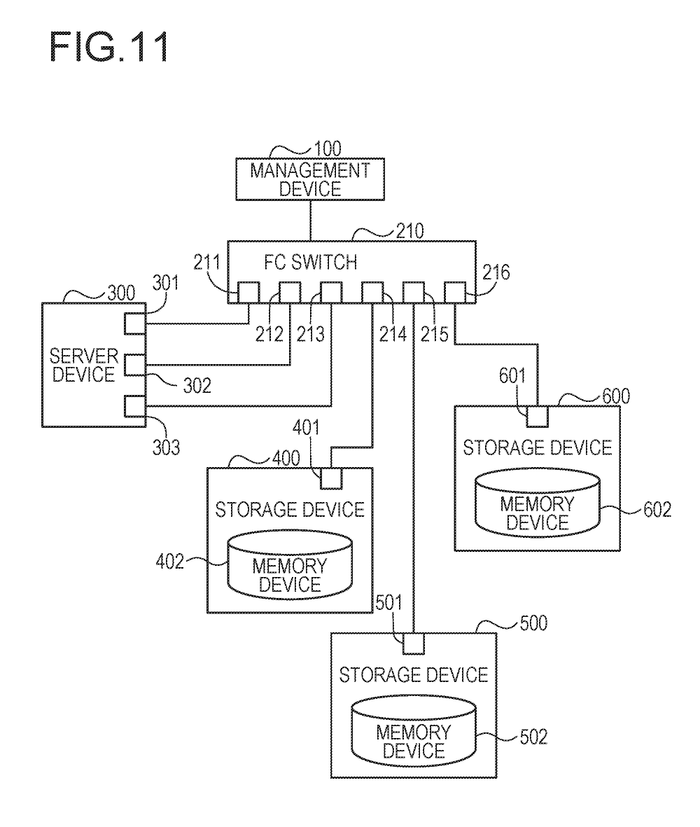

A storage system according to Modification#1 is configured as illustrated in, for example, FIG. 11. FIG. 11 is a diagram illustrating an example of a storage system according to a modification (Modification#1) of the second embodiment. As illustrated in FIG. 11, an FC switch 210 according to Modification#1 includes six connection ports 211 to 216. The server device 300 includes three connection ports 301 to 303. Further, the storage system includes, in addition to the storage devices 400 and 500, a storage device 600 including a CA 601.

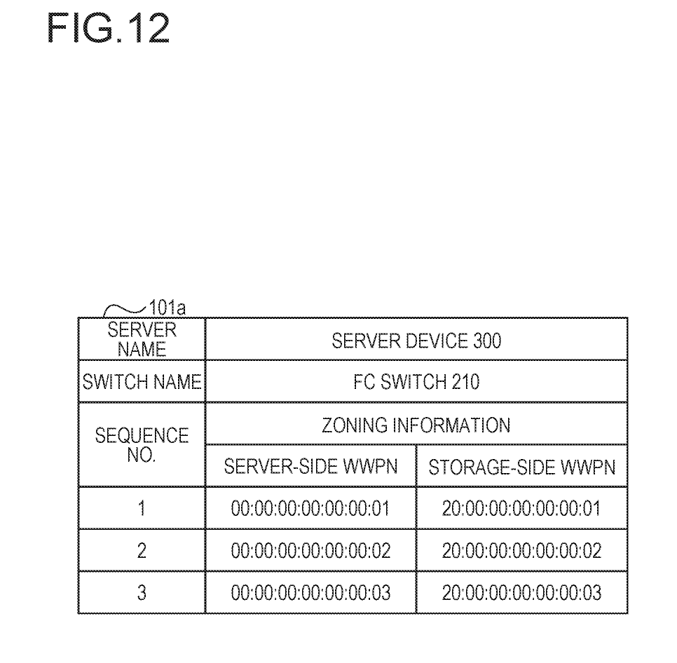

When the system is expanded as described above, recognition sequence information 101a is set as illustrated in FIG. 12. FIG. 12 is a diagram illustrating an example of recognition sequence information according to a modification (Modification#1) of the second embodiment. As illustrated in FIG. 12, zoning information corresponding to Sequence No. 3 is added as the HBA 303 (WWPN: 00:00:00:00:00:00:03) and the CA 601 of the storage device 600 (WWPN: 20:00:00:00:00:00:03) are added to the system.

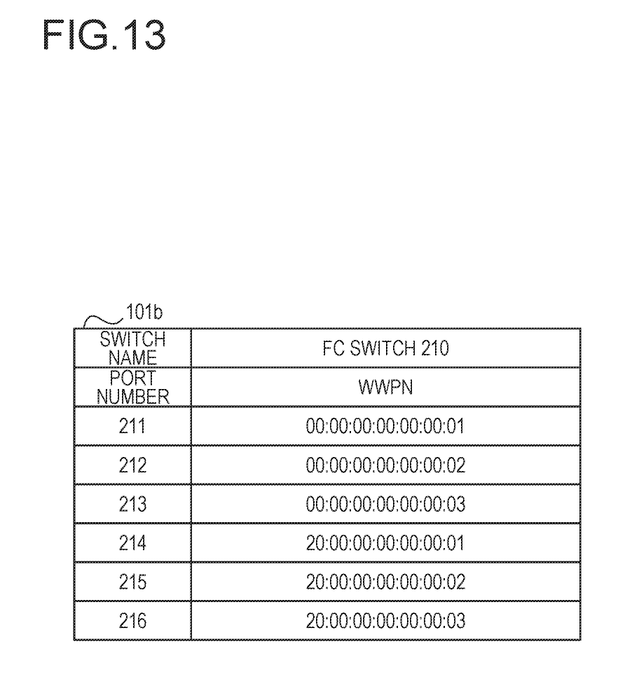

Connection line information 101b is set as illustrated in FIG. 13. FIG. 13 is a diagram illustrating an example of connection line information according to the modification (Modification#1) of the second embodiment. As illustrated in FIG. 13, WWPNs of the FC ports (the HBAs 301 to 303 and the CAs 401, 501, and 601) which are respectively connected to the six connection ports 211 to 216 are registered as connection line information 101b. When the system is expanded as described above, information to be registered in the recognition sequence information 101a and the connection line information 101b increases, but the operation performed by the management device 100 (see FIG. 8) are the same.

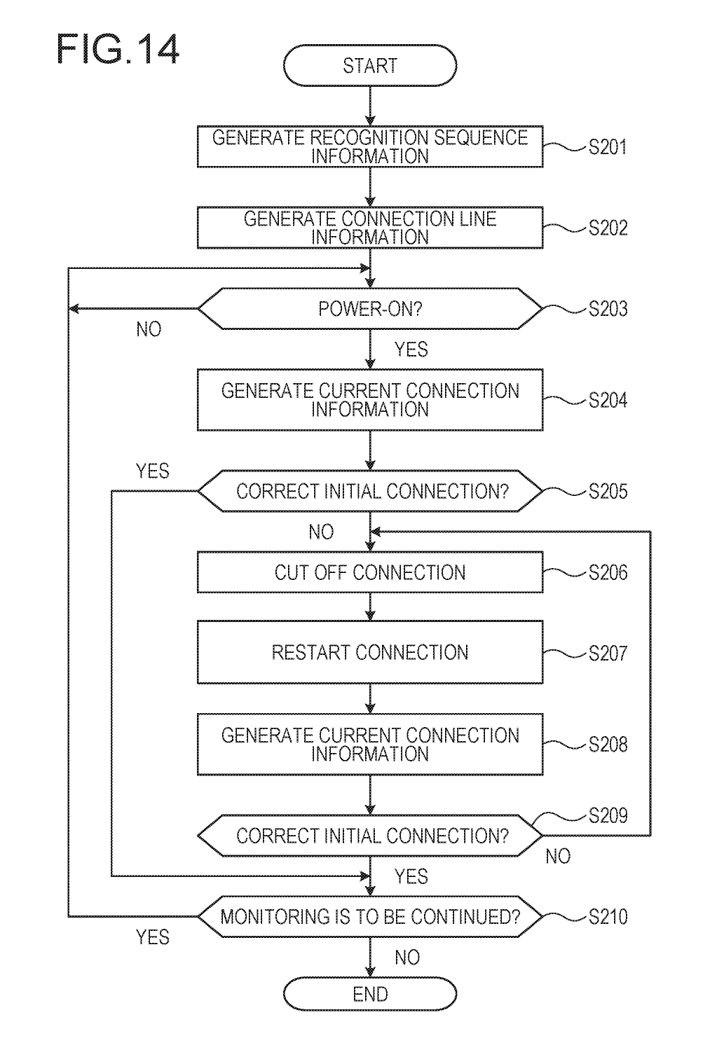

Here, a modification (Modification#2) to simplify the operations performed by the management device 100 will be described with reference to FIG. 14. FIG. 14 is a flowchart illustrating a flow of operations performed by the management device according to the modification (Modification#2) of the second embodiment.

(S201) The sequence management unit 102 generates recognition sequence information 101a. For example, as illustrated in FIG. 12, the sequence management unit 102 registers pairs of a server-side WWPN and a storage-side WWPN as recognition sequence information 101a in a preset sequence.

(S202) The sequence management unit 102 generates connection line information 101b. For example, the sequence management unit 102 acquires WWPNs of the FC ports connected to the FC switch 200 and registers the WWPNs corresponding to the connection ports 211 to 216, respectively, as the connection line information 101b as illustrated in FIG. 13.

(S203) The recognition controller 103 monitors the power-on of the server device 300. When the power-on of the server device 300 is detected, the processing proceeds to S204. When the power-on of the server device 300 is not detected, the processing proceeds to S203 again, and the recognition controller 103 continues to monitor the power-on.

(S104) The recognition controller 103 monitors a login (FC port login) to the FC switch 210 by the server device 300. When an FC port login is performed, the recognition controller 103 generates current connection information 101c on the basis of the log of the FC port login.

For example, the recognition controller 103 acquires the log of the FC port login from the FC switch 210, and identifies a server-side WWPN and a storage-side WWPN which correspond to a path for which the FC port login has been completed. Then, the recognition controller 103 registers the identified server-side WWPN and storage-side WWPN as current connection information 101c while associating the WWPNs with the completion sequence of the FC port login.

(S205) The recognition controller 103 compares the recognition sequence information 101a and the current connection information 101c generated in S204 with each other and determines whether the initial connection is correct. That is, the recognition controller 103 determines whether the zoning information corresponding to Sequence No. 1 of the recognition sequence information 101a and the pair of the WWPNs corresponding to Sequence No. 1 of the current connection information 101c are consistent with each other. When it is determined that the initial connection is correct, the processing proceeds to S210. When it is determined that the initial connection is incorrect, the processing proceeds to S206.

(S206) The recognition controller 103 cuts off the connections to the FC switch 210 with respect to the pairs of the WWPNs recorded in the current connection information 101c. For example, the recognition controller 103 makes all the connection ports corresponding to the respective server-side WWPNs recorded in the current connection information 101c to be offline, with reference to the connection line information 101b. Further, the recognition controller 103 makes all the connection ports corresponding to the storage-side WWPNs to be offline.

(S207) The recognition controller 103 sequentially restarts the connection of the ports from the port corresponding to Sequence No. 1 of the recognition sequence information 101a.

For example, with reference to the recognition sequence information 101a and the connection line information 101b, the recognition controller 103 makes the connection port 211 (Port No. 211) corresponding to the server-side WWPN (00:00:00:00:00:00:01) which corresponds to Sequence No. 1 to be online. Subsequently, the recognition controller 103 makes the connection port 214 (Port No. 214) corresponding to the storage-side WWPN (20:00:00:00:00:00:01) which corresponds to Sequence No. 1 to be online. Subsequently, the recognition controller 103 makes the other connection ports 212, 213, 215, and 216 to be online.

(S208) The recognition controller 103 monitors a login (FC port login) to the FC switch 210 by the server device 300. When the FC port login is performed, the recognition controller 103 generates current connection information 101c on the basis of the log of the FC port login.

For example, the recognition controller 103 acquires the log of the FC port login from the FC switch 210, and identifies a server-side WWPN and a storage-side WWPN which correspond to a path for which the FC port login has been completed. Then, the recognition controller 103 registers the identified server-side WWPN and storage-side WWPN as current connection information 101c while associating the WWPNs with the completion sequence of the FC port login.

(S209) The recognition controller 103 compares the recognition sequence information 101a and the current connection information 101c generated in S208 with each other and determines whether the initial connection is correct. That is, the recognition controller 103 determines whether the zoning information corresponding to Sequence No. 1 of the recognition sequence information 101a and the pair of the WWPNs corresponding to Sequence No. 1 of the current connection information 101c are consistent with each other. When it is determined that the initial connection is correct, the processing proceeds to S210. When it is determined that the initial connection is incorrect, the processing proceeds to S206.

After confirming the connection of the path corresponding to Sequence No. 1 in S207, the recognition controller 103 may make the other connection ports 212, 213, 215, and 216 to be online. In this case, S209 may be omitted.

(S210) The recognition controller 103 determines whether to continue the monitoring of the power-on. For example, when a user instructs to end the monitoring, it is determined that the monitoring of the power-on is not to be continued. When it is determined that the monitoring of the power-on is to be continued, the processing proceeds to S203. When it is determined that the monitoring of the power-on is not to be continued, the series of the operations illustrated in FIG. 14 are ended.

As described above, in Modification#2, the recognition controller 103 checks the recognition sequence information 101a and the current connection information 101c only for the path corresponding to Sequence No. 1 rather than all sequence numbers. Since the OS image is stored in an initially connected storage device, the OS may be normally started as long as the storage device may be correctly recognized. The check operation is simplified so that the time or load for the reconnection processing may be reduced.

The second embodiment has been described.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A management device, comprising:
a memory device configured to
store therein recognition sequence information indicating an expected sequence of recognition processing for recognizing each of paths interconnecting any one of first connection units and any one of second connection units, the recognition processing being performed at a time of power-on of a server device including the first connection units, the second connection units being included in respective storage devices, each of the first connection units and the second connection units being connected to any one of connection ports included in a switch; and
a processor configured to
monitor a sequence of the recognition processing at the time of power-on, and
control the switch, upon detecting a first path for which the recognition processing is performed in a different sequence from the expected sequence, to temporarily cut off connection ports existing on the first path.

2. The management device according to claim 1, wherein the processor is configured to
control the switch to reconnect the connection ports which have been temporarily cut off.

3. The management device according to claim 1, wherein
the storage devices include a first storage device and a second storage device, the first storage device storing therein a program of an operating system used by the server device, the second storage device not storing therein the program,
the server device is operated, at the time of power-on, to read and execute the program from a storage device for which the recognition processing is first completed, and
the expected sequence indicates that the recognition processing for a path connected to a second connection unit included in the first storage device is to be performed first.

4. The management device according to claim 3, wherein
the processor is configured to
avoid the cut-off of connection ports with respect to a path for which the recognition processing is performed secondarily or later in a different sequence from the expected sequence.

5. A method for controlling connections of a storage network, the method comprising:
acquiring by a computer, from a memory device, recognition sequence information indicating an expected sequence of recognition processing for recognizing each of paths interconnecting any one of first connection units and any one of second connection units, the recognition processing being performed at a time of power-on of a server device including the first connection units, the second connection units being included in respective storage devices included in the storage network, each of the first connection units and the second connection units being connected to any one of connection ports included in a switch;
monitoring a sequence of the recognition processing at the time of power-on; and
controlling the switch, upon detecting a first path for which the recognition processing is performed in a different sequence from the expected sequence, to temporarily cut off connection ports existing on the first path.

6. A non-transitory computer-readable recording medium having stored therein a program that causes a computer to execute a process, the process comprising:
acquiring, from a memory device, recognition sequence information indicating an expected sequence of recognition processing for recognizing each of paths interconnecting any one of first connection units and any one of second connection units, the recognition processing being performed at a time of power-on of a server device including the first connection units, the second connection units being included in respective storage devices, each of the first connection units and the second connection units being connected to any one of connection ports included in a switch;
monitoring a sequence of the recognition processing at the time of power-on; and
controlling the switch, upon detecting a first path for which the recognition processing is performed in a different sequence from the expected sequence, to temporarily cut off connection ports existing on the first path.
